(19) United States
(12) Patent Application Publication
(10) Pub. No.: US 2025/0384672 A1
(43) Pub. Date: Dec. 18, 2025

(54) SINGLE CHARACTER DETECTION METHOD, TRAINING METHOD FOR MODEL, DEVICE, APPARATUS AND MEDIUM

(71) Applicant: BOE TECHNOLOGY GROUP CO., LTD., Beijing (CN)

(72) Inventor: Pan ZHONG, Beijing (CN)

(21) Appl. No.: 18/994,738

(22) PCT Filed: Mar. 31, 2023
(86) PCT No.: PCT/CN2023/085527

§ 371 Date: Jan. 15, 2025

(51) Int. Cl. G06V 10/774; G06V 10/44; G06V 10/764; G06V 10/77; G06V 10/776; G06V 10/82; G06V 20/62; G06V 30/18; G06V 30/19; G06V 30/28

(52) U.S. Cl. CPC G06V 10/7747; G06V 10/457; G06V 10/764; G06V 10/7715; G06V 10/776; G06V 10/82; G06V 20/63; G06V 30/18076; G06V 30/19127; G06V 30/1916; G06V 30/19173; G06V 30/287

(57) ABSTRACT

A training method includes: obtaining a synthesis text image set, a synthesis text image being obtained through synthesizing a real scenario background image and a random word, the synthesis text image being provided with a line text annotation box and a single character annotation box; training an initial algorithm network using the synthesis text image set, so as to obtain an intermediate model; processing a real scenario text image set using the intermediate model, so as to obtain a pseudo label of a real scenario text image, the real scenario text image being provided with a line text annotation box, the pseudo label being a single character annotation box; and training the intermediate model using the synthesis text image set and the real scenario text image set having the pseudo label, so as to obtain the single character detection model.

### TECHNICAL FIELD

The present disclosure relates to the field of text detection, in particular to a single character detection method, a training method for a model, a device, an apparatus and a medium.

### BACKGROUND

In a current text detection dataset, there are few annotations at a single-character level (for Chinese, a single character refers to a single Chinese character, and for English, the single character refers to a single letter), so there are few training samples for the training of a single character detection model, and thereby the accuracy of the resultant single character detection model is insufficient.

In the related art, a line text detection algorithm has been presented to locate a single character region and link the detected characters into a text. However, an ultimate aim of this algorithm is to achieve line text detection, so the positioning accuracy of the single character is not highly demanded. For an English text, such a problem as touching characters easily occurs, and for a Chinese text, such a problem as false detection of radicals easily occurs.

### SUMMARY

An object of the present disclosure is to provide a single character detection method, a training method of a model, a device, an apparatus and a medium, so as to solve the problem in the related art where the accuracy of a single character detection model obtained through training is insufficient due to the lack of annotations at a single-character level.

In order to solve the above-mentioned technical problem, the present disclosure provides the following technical solutions.

In one aspect, the present disclosure provides in some embodiments a single character detection method, including: obtaining a to-be-detected text image; and performing single character detection on the to-be-detected text image through a single character detection model, and generating a single character detection box for the to-be-detected text image, the single character detection model being obtained through training with a synthesis text image set and a real scenario text image set, a synthesis text image in the synthesis text image set being obtained through synthesizing a real scenario background image and a random word, the synthesis text image being provided with a line text annotation box and a single character annotation box, and a real scenario text image in the real scenario text image set being provided with a line text annotation box.

In a possible embodiment of the present disclosure, the single character detection model uses a multi-scale feature fusion residual network.

In a possible embodiment of the present disclosure, the synthesis text image set includes at least one of a single Chinese character synthesis text image set or a single English character synthesis text image set.

In a possible embodiment of the present disclosure, the performing the single character detection on the to-be-detected text image through the single character detection model and generating the single character detection box for the to-be-detected text image includes: performing the single character detection on the to-be-detected text image, so as to obtain a region score prediction image and an affinity score prediction image; performing binarization on the region score prediction image and the affinity score prediction image, so as to obtain a text region mask image and an affinity mask image; determining a single character partition mask image in accordance with the affinity mask image; subtracting the single character partition mask image from the text region mask image, so as to obtain a plurality of second connected regions on the text region mask image; deleting the connected regions meeting a second condition from the plurality of second connected regions, so as to obtain a remaining target second connected region, the second condition including a condition about an area of the second connected region and/or a condition about a height of a center of the second connected region; and dilating the target second connected region, and taking a minimum bounding pattern for the dilated target second connected region as a predicted single character annotation box.

In a possible embodiment of the present disclosure, the determining the single character partition mask image in accordance with the affinity mask image includes: determining a plurality of first connected regions in the affinity mask image; deleting connected regions meeting a first condition from the plurality of first connected regions, so as to obtain a remaining target first connected region, the first condition including a condition about an area of the first connected region and/or a condition about a height of a center of the first connected region; obtaining maximum coordinate values of the target first connected region; and generating, with a point corresponding to the maximum coordinate values as a center, a partition bar whose width is equal to the predetermined quantity of pixels, so as to obtain the single character partition mask image including the partition bar.

In a possible embodiment of the present disclosure, the first condition includes at least one of that a ratio of an area of the first connected region to an area of the affinity mask image is smaller than a second threshold, or that |region_yc−link_h//2|>link_h//3, where region_yc represents a y-axis coordinate of a center of the first connected region, and link_h represents a height of the affinity mask image; and/or the second condition includes at least one of that a ratio of an area of the second connected region to an area of the to-be-detected text image is smaller than a third threshold, that |region_yc−crop_img_h//2|>crop_img_h//3, or that max(text_map[region])<min_text_thre, where region_yc represents a y-axis coordinate of a center of the second connected region, crop_img_h represents a height of the to-be-detected text image, max(text_map[region]) represents a maximum value of region scores corresponding to single character connected regions in the region score prediction image, and min_text_thre represents a single character threshold.

In a possible embodiment of the present disclosure, prior to subtracting the single character partition mask image from the text region mask image, the single character detection method further includes eroding the text region mask image. The subtracting the single character partition mask image from the text region mask image includes: with respect to each second connected region, when an overlapping area between the partition bar and the second connected region is greater than a fourth threshold and a difference between the height of the center of the second connected region and the height of the center of the first connected region in the corresponding affinity mask image is greater than a fifth threshold, determining that there is a plurality of rows of words in a line text annotation box in the region score prediction image; and defining a height of the partition bar in accordance with the second connected region in the text region mask image.

In another aspect, the present disclosure provides in some embodiments a training method of a single character detection model, including: obtaining a synthesis text image set, a synthesis text image in the synthesis text image set being obtained through synthesizing a real scenario background image and a random word, the synthesis text image being provided with a line text annotation box and a single character annotation box; training an initial algorithm network using the synthesis text image set, so as to obtain an intermediate model for single character detection; processing a real scenario text image set using the intermediate model, so as to obtain a pseudo label of a real scenario text image in the real scenario text image set, the real scenario text image being provided with a line text annotation box, the pseudo label being a single character annotation box; and training the intermediate model using the synthesis text image set and the real scenario text image set having the pseudo label, so as to obtain the single character detection model for single character detection.

In a possible embodiment of the present disclosure, the synthesis text image set includes at least one of a single Chinese character synthesis text image set or a single English character synthesis text image set.

In a possible embodiment of the present disclosure, the obtaining the synthesis text image set includes: selecting a real scenario background image; partitioning the real scenario background image into a plurality of partition regions, the partition regions having a same texture and/or a same color; performing image depth estimation on the real scenario background image, so as to obtain depth information about each partition region in the real scenario background image; screening the partition regions in accordance with a size and an aspect ratio of each partition region and/or the depth information about the partition region, so as to obtain candidate regions; randomly selecting the candidate regions; with respect to each selected candidate region, performing the following operations until all the candidate regions have been processed: rendering a randomly-selected word in accordance with a color of the candidate region, so as to obtain the rendered word; obtaining a minimum bounding rectangle of the candidate region; obtaining a space plane corresponding to the minimum bounding rectangle in accordance with the depth information about the candidate region; performing perspective transformation on the candidate region in accordance with the space plane, so as to transform the space plane of the candidate region into a target plane parallel to a screen; pasting the rendered word to the transformed candidate region; and performing inverse perspective transformation on the transformed candidate region; and mapping all the processed candidate regions back to the real scenario background image to obtain the synthesis text image, and determining the line text annotation box and the single character annotation box in the synthesis text image.

In a possible embodiment of the present disclosure, the initial algorithm network, the intermediate model and the single character detection model use a multi-scale feature fusion residual network.

In a possible embodiment of the present disclosure, prior to processing the real scenario text image set using the intermediate model, the training method further includes: with respect to a line text annotation box including four vertices in the real scenario text image, performing the following operations: obtaining a height and a width of the line text annotation box; when the line text annotation box is determined as an annotation box in a first direction in accordance with the height and width of the line text annotation box, performing perspective transformation on a screenshot of a region where the line text annotation box is located so as to obtain a cropped image in a second direction, and scaling the cropped image in the second direction so as to obtain a training image adapted to the intermediate model; and when the line text annotation box is determined as an annotation box in the second direction in accordance with the height and width of the line text annotation box, directly scaling a screenshot of a region where the annotation box in the second direction, so as to obtain a training image adapted to the intermediate model; and/or with respect to a line text annotation box including N vertices in the real scenario text image, performing the following operations: obtaining a minimum bounding rectangle of the line text annotation box, and obtaining a ratio of an area of the line text annotation box and an area of the minimum bounding rectangle; when the ratio is smaller than a first threshold, determining that the line text annotation box is a curved annotation box, obtaining a training image adapted to the intermediate model in accordance with four vertices of the minimum bounding rectangle, and setting values of pixels in a region of the training image other than the line text annotation box as 0; and when the ratio is greater than or equal to the first threshold, determining that the line text annotation box is an approximately rectangular annotation box, and obtaining a training image adapted to the intermediate model in accordance with the four vertices of the minimum bounding rectangle, where N is greater than 4. The obtaining the training image adapted to the intermediate model in accordance with the four vertices of the minimum bounding rectangle includes: obtaining a height and a width of the minimum bounding rectangle; when the minimum bounding rectangle is determined as an annotation box in a first direction in accordance with the height and width of the minimum bounding rectangle, performing perspective transformation on a screenshot of a region where the minimum bounding rectangle is located so as to obtain a cropped image in a first direction, and scaling the cropped image in the second direction so as to obtain a training image adapted to the intermediate model; and when the minimum bounding rectangle is determined as an annotation box in the second direction in accordance with the height and the width of the minimum bounding rectangle, directly scaling the screenshot of the region where the minimum bounding rectangle is located, so as to obtain a training image adapted to the intermediate model.

In a possible embodiment of the present disclosure, when the line text annotation box in the real scenario text image includes Chinese characters, prior to performing the perspective transformation on the line text annotation box or the screenshot of the region where the minimum bounding rectangle is located, the training method further includes: determining whether a text is a longitudinal text in accordance with whether the height of the line text annotation box or the minimum bounding rectangle is greater than a product of the width of the line text annotation box or the minimum bounding rectangle and a predetermined factor; when the height of the line text annotation box or the minimum bounding rectangle is greater than the product of the width and the predetermined factor, determining that the text is a longitudinal text, and enlarging the width of the line text annotation box or the minimum bounding rectangle by a predetermined proportion; and when the height of the line text annotation box or the minimum bounding rectangle is smaller than or equal to the product of the width and the predetermined factor, determining that the text is not a longitudinal text, and enlarging the height of the line text annotation box or the minimum bounding rectangle by a predetermined proportion.

In a possible embodiment of the present disclosure, the training method further includes: generating an inter-character region annotation box in accordance with a single character annotation box in a training image, the inter-character region annotation box being obtained through obtaining diagonal lines of each single character annotation box of two adjacent single character annotation boxes, the single character annotation box being divided into four triangles through the diagonal lines, and connecting centers of upper and lower triangles of the two adjacent single character annotation boxes to obtain the inter-character region annotation box, the training image including the synthesis text image and/or the real scenario text image having the pseudo label; encoding the single character annotation box and the inter-character region annotation box in the training image using a Gaussian function, so as to obtain two-dimensional isotropic Gaussian maps for the single character annotation box and the inter-character region annotation box; performing perspective transformation on the two-dimensional isotropic Gaussian map for the single character annotation box, and mapping the transformed two-dimensional isotropic Gaussian map into the single character annotation box, so as to obtain a first intermediate image; mapping the two-dimensional isotropic Gaussian map for the inter-character region annotation box into the inter-character region annotation box, so as to obtain a second intermediate image; and processing the first intermediate image and the second intermediate image, and outputting a region score truth-value image and an affinity score truth-value image, a region score representing a probability that each pixel in the single character annotation box is a character center, an affinity score representing a probability that each pixel in the inter-character region annotation box is a center of an inter-character region, the region score truth-value image and the affinity score truth-value image being used to train the initial algorithm network or the intermediate model.

In a possible embodiment of the present disclosure, the processing the real scenario text image set using the intermediate model so as to obtain the pseudo label of the real scenario text image in the real scenario text image set includes: performing binarization on a region score prediction image and an affinity score prediction image from the intermediate model, so as to obtain a text region mask image and an affinity mask image; determining a single character partition mask image in accordance with the affinity mask image; subtracting the single character partition mask image from the text region mask image, so as to obtain a plurality of second connected regions on the text region mask image; deleting the connected regions meeting a second condition from the plurality of second connected regions, so as to obtain a remaining target second connected region, the second condition including a condition about an area of the second connected region and/or a condition about a height of a center of the second connected region; and dilating the target second connected region, and taking a minimum bounding pattern for the dilated target second connected region as a predicted single character annotation box.

In a possible embodiment of the present disclosure, the determining the single character partition mask image in accordance with the affinity mask image includes: determining a plurality of first connected regions in the affinity mask image; deleting connected regions meeting a first condition from the plurality of first connected regions, so as to obtain a remaining target first connected region, the first condition including a condition about an area of the first connected region and/or a condition about a height of a center of the first connected region; obtaining maximum coordinate values of the target first connected region; and generating, with a point corresponding to the maximum coordinate values as a center, a partition bar whose width is equal to the predetermined quantity of pixels, so as to obtain the single character partition mask image including the partition bar.

In a possible embodiment of the present disclosure, the first condition includes at least one of that a ratio of an area of the first connected region to an area of the affinity mask image is smaller than a second threshold, or that |region_yc−link_h//2|>link_h//3, where region_yc represents a y-axis coordinate of a center of the first connected region, and link_h represents a height of the affinity mask image; and/or the second condition includes at least one of that a ratio of an area of the second connected region to an area of the to-be-detected text image is smaller than a third threshold, that |region_yc−crop_img_h//2|>crop_img_h//3, or that max(text_map[region])<min_text_thre, where region_yc represents a y-axis coordinate of a center of the second connected region, text_h represents a height of the text region mask image, max(text_map[region]) represents a maximum value of region scores corresponding to single character connected regions in the region score prediction image, and min_text_thre represents a single character threshold.

In a possible embodiment of the present disclosure, prior to subtracting the single character partition mask image from the text region mask image, the training method further includes eroding the text region mask image. The subtracting the single character partition mask image from the text region mask image includes: with respect to each second connected region, when an overlapping area between the partition bar and the second connected region is greater than a fourth threshold and a difference between the height of the center of the second connected region and the height of the center of the first connected region in the corresponding affinity mask image is greater than a fifth threshold, determining that there is a plurality of rows of words in a line text annotation box in the region score prediction image; and defining a height of the partition bar in accordance with the second connected region in the text region mask image.

In a possible embodiment of the present disclosure, each pseudo label corresponds to a confidence level. The training the intermediate model using the synthesis text image set and the real scenario text image set having the pseudo label includes: calculating a loss in accordance with the confidence level of the pseudo label; and adjusting a parameter of the intermediate model in accordance with the loss.

In a possible embodiment of the present disclosure, the confidence level is calculated through

$${S}_{conf} ( w ) = \frac{l ( w ) - min ( l ( w ) , \vert l ( w ) - {l}^{c} ( w ) \vert )}{l ( w )} ,$$

where S_{conf}(w) represents the confidence level, l(w) represents the quantity of characters annotated manually, and l^{c}(w) represents the predicted quantity of characters. When the confidence level is smaller than a fifth threshold and the line text annotation box in the training image is a rectangular annotation box, the confidence level is reset to the fifth threshold, and when the confidence level is smaller than the fifth threshold and the line text annotation box in the training image is a curved annotation box, the confidence level is reset to 0.

In yet another aspect, the present disclosure provides in some embodiments a single character detection device, including: an obtaining module configured to obtain a to-be-detected text image; and a single character detection module configured to perform single character detection on the to-be-detected text image through a single character detection model, and generate a single character detection box for the to-be-detected text image, the single character detection model being obtained through training with a synthesis text image set and a real scenario text image set, a synthesis text image in the synthesis text image set being obtained through synthesizing a real scenario background image and a random word, the synthesis text image being provided with a line text annotation box and a single character annotation box, and a real scenario text image in the real scenario text image set being provided with a line text annotation box.

In still yet another aspect, the present disclosure provides in some embodiments a training device for a single character detection model, including: a first obtaining module configured to obtain a synthesis text image set, a synthesis text image in the synthesis text image set being obtained through synthesizing a real scenario background image and a random word, the synthesis text image being provided with a line text annotation box and a single character annotation box; a first training module configured to train an initial algorithm network using the synthesis text image set, so as to obtain an intermediate model for single character detection; a pseudo label obtaining module configured to process a real scenario text image set using the intermediate model, so as to obtain a pseudo label of a real scenario text image in the real scenario text image set, the real scenario text image being provided with a line text annotation box, the pseudo label being a single character annotation box; and a second training module configured to train the intermediate model using the synthesis text image set and the real scenario text image set having the pseudo label, so as to obtain the single character detection model for single character detection.

In still yet another aspect, the present disclosure provides in some embodiments an electronic apparatus, including a processor, a memory, and a program stored in the memory and executed by the processor. The program is executed by the processor so as to implement the steps of the above-mentioned single character detection method, or the steps of the above-mentioned training method for the single character detection model.

In still yet another aspect, the present disclosure provides in some embodiments a non-transient computer-readable storage medium storing therein a computer program. The computer program is executed by a processor so as to implement the steps of the above-mentioned single character detection method, or the steps of the above-mentioned training method for the single character detection model.

According to the embodiments of the present disclosure, the single character detection model is trained using the synthesis text image obtained through synthesizing the real scenario background image and the random word and having the single character annotation, so it is able to solve the problem caused by the lack of annotation text at a single-character level during the training. In addition, the training is performed in conjunction with the real scenario text image set having the line text annotation, so it is able to increase the accuracy of the single character detection model.

### BRIEF DESCRIPTION OF THE DRAWINGS

Through reading the detailed description hereinafter, the other advantages and benefits will be apparent to a person skilled in the art. The drawings are merely used to show the preferred embodiments, but shall not be construed as limiting the present disclosure. In addition, in the drawings, same reference symbols represent same members. In these drawings,

FIG. 1 is a flow chart of a training method for a single character detection model according to one embodiment of the present disclosure;

FIG. 2 is a schematic view showing an improved CRAFT network according to one embodiment of the present disclosure;

FIG. 3 is a schematic view showing a method for enlarging a height or width of a line text annotation box or a minimum bounding rectangle according to one embodiment of the present disclosure;

FIG. 4 is a schematic view showing a method for transforming a single character annotation box and an inter-character region annotation box into a region score truth-value image and an affinity score truth-value image according to one embodiment of the present disclosure;

FIG. 5 is a schematic view showing a method for generating a pseudo label according to one embodiment of the present disclosure;

FIG. 6 is a flow chart of a single character detection method according to one embodiment of the present disclosure;

FIG. 7 is a schematic view showing a training device for a single character detection model according to one embodiment of the present disclosure;

FIG. 8 is a schematic view showing a single character detection device according to one embodiment of the present disclosure; and

FIG. 9 is a schematic view showing an electronic apparatus according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

As shown in FIG. 1, the present disclosure provides in some embodiments a training method for a single character detection model, which includes the following steps.

Step 11: obtaining a synthesis text image set, a synthesis text image in the synthesis text image set being obtained through synthesizing a real scenario background image and a random word, the synthesis text image being provided with a line text annotation box and a single character annotation box.

In the embodiments of the present disclosure, for Chinese, a single character refers to a single Chinese character, and for English, the single character refers to a single English letter (or character).

In a possible embodiment of the present disclosure, the synthesis text image set includes at least one of a single Chinese character synthesis text image set or a single English character synthesis text image set.

When the synthesis text image set includes both the single Chinese character synthesis text image set and the single English character synthesis text image set, it is able for the model to detect a single Chinese character and a single English character.

In a possible embodiment of the present disclosure, the obtaining the synthesis text image set includes generating the synthesis text image set, e.g., generating the single Chinese character synthesis text image set. Of course, in some embodiments of the present disclosure, an existing synthesis text image set, e.g., SynthText, may be selected. The SynthText is a large-scale data set including about 800K English character synthesis text images, and these synthesis text images are obtained through mixing real scenario background images with random characters.

Step 12: training an initial algorithm network using the synthesis text image set, so as to obtain an intermediate model for single character detection.

Step 13: processing a real scenario text image set using the intermediate model, so as to obtain a pseudo label of a real scenario text image in the real scenario text image set, the real scenario text image being provided with a line text annotation box, the pseudo label being a single character annotation box. One or more lines of text on an image is annotated by the line text annotation box. The real scenario text image set refers to real images, e.g., bills, business cards or shop signs.

Step 14: training the intermediate model using the synthesis text image set and the real scenario text image set having the pseudo label, so as to obtain the single character detection model for single character detection.

Due to the lack of data with single-character annotations, in the embodiments of the present disclosure, an annotation at a single-character level is generated from an annotation at a line text level in the real scenario text image set, so as to fine-tune the intermediate model.

According to the embodiments of the present disclosure, the single character detection model is trained using the synthesis text image obtained through synthesizing the real scenario background image and the random word and having the single character annotation, so it is able to solve the problem caused by the lack of annotation text at a single-character level during the training. In addition, the training is performed in conjunction with the real scenario text image set having the line text annotation, so it is able to increase the accuracy of the single character detection model.

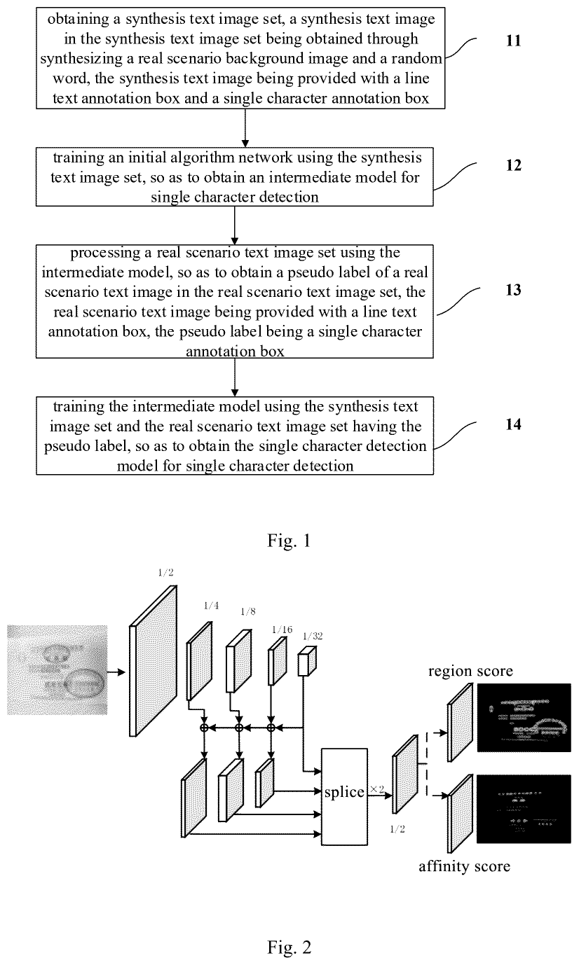

In a possible embodiment of the present disclosure, the initial algorithm network, the intermediate model and the single character detection model use an improved Character Region Awareness For Text detection (CRAFT) network. The improved CRAFT uses a multi-scale feature fusion residual network, e.g., an ResNet50+FPN structure, as shown in FIG. 2. In the improved CRAFT, an original VGG16_bn is replaced with ResNet50 as a backbone network, so as to provide faster network convergence and stronger feature extraction capability due to the advantage of residual connection. Multi-scale features are aggregated through the FPN, so as to be adapted to the scenarios where there is a large difference between sizes of characters, e.g., business cards or paper documents. After aggregating the multi-scale features from the FPN, the quantity of channels of the model is gradually compressed through two convolutional layers (four convolutional layers are used for compression in an original model, and here the quantity of convolutional layers is reduced due to the deeper ResNet50), and finally 2-channel prediction probability graphs are outputted. The prediction probability graph has a size of W/2*H/2*2, where W represents a width of a training image, and H represents a height of the training image. The two prediction probability graph include a region score prediction image and an affinity score prediction image. The region score prediction image indicates a region score, and the region score indicates a probability that each pixel is a center of a character. The affinity score prediction image indicates an affinity score, and the affinity score indicates a probability that each pixel is a center of an inter-character region.

The intermediate model is further used to transform the region score prediction image and the affinity score prediction image into pseudo labels. A specific transformation method will be described hereinafter.

A method for generating the synthesis text image in the embodiments of the present disclosure will be described hereinafter.

In a possible embodiment of the present disclosure, the obtaining the synthesis text image set includes the following steps.

Step 111: selecting a real scenario background image.

For example, a current to-be-processed real scenario background image is selected randomly from a plurality of real scenario background images. The so-called real scenario text image set includes real images.

Step 112: partitioning the real scenario background image into a plurality of partition regions, the partition regions having a same texture and/or a same color.

In the embodiments of the present disclosure, the selected real scenario background image is partitioned through a gPb-UCM algorithm in accordance with a local color and/or texture.

Step 113: performing image depth estimation on the real scenario background image, so as to obtain depth information about each partition region in the real scenario background image.

In the embodiments of the present disclosure, the image depth estimation is performed on the real scenario background image through a Convolutional Neural Network (CNN).

The image depth estimation aims to obtain different planes in the real scenario background image for the pasting of words, so as to achieve an approximately real effect.

Step 114: screening the partition regions in accordance with a size and an aspect ratio of each partition region and/or the depth information about the partition region, so as to obtain candidate regions. Each candidate region is used for the pasting of words.

In a possible embodiment of the present disclosure, when screening the partition regions, the partition regions having a small size, the partition regions having an extreme aspect ratio, and/or the partition regions where no complete plane is formed may be removed. Each candidate region is indicated through contour points.

Step 115: randomly selecting the candidate regions.

Step 116: with respect to each selected candidate region, performing the following operations until all the candidate regions have been processed: rendering a randomly-selected word in accordance with a color of the candidate region, so as to obtain the rendered word; obtaining a minimum bounding rectangle of the candidate region; obtaining a space plane corresponding to the minimum bounding rectangle in accordance with the depth information about the candidate region; performing perspective transformation on the candidate region in accordance with the space plane, so as to transform the space plane of the candidate region into a target plane parallel to a screen; pasting the rendered word to the transformed candidate region; and performing inverse perspective transformation on the transformed candidate region.

In the embodiments of the present disclosure, the space plane where the candidate region is located is not necessarily the target plane parallel to the screen, so it is necessary to perform perspective transformation to transform the space plane of the candidate region into the target plane parallel to the screen, then render the word, and then perform the inverse perspective transformation on the candidate region to be back to the original space plane. At this time, the rendered word is provided with a perspective effect, so as to be close to a real scenario.

In the embodiments of the present disclosure, the perspective transformation includes estimating a normal vector of the space plane of the candidate region, and rotating the normal vector so as to transform the space plane of the candidate region into the target plane parallel to the screen.

Step 117: mapping all the processed candidate regions back to the real scenario background image to obtain the synthesis text image, and determining the line text annotation box and the single character annotation box in the synthesis text image.

A pasting position and a pasted word are known during the pasting, so it is able to obtain the line text annotation box and the single character annotation box.

In a possible embodiment of the present disclosure, the rendering the randomly-selected word in accordance with the color of the candidate region includes determining a color of the randomly-selected word in accordance with the color of the candidate region. For example, the color of the candidate region is inputted into a color model, so as to obtain the color of the randomly-selected word.

In a possible embodiment of the present disclosure, a font of the randomly-selected word is generated randomly.

In the embodiments of the present disclosure, the generated synthesis text image includes at least one of a single Chinese character synthesis text image or a single English character synthesis text image.

In a possible embodiment of the present disclosure, when pasting the rendered word to the target plane, a left end point and a right end point of the word (a left end point and a right end point of a line when the rendered word includes more than one word) are flush with a left side and a right side of the minimum bounding rectangle respectively, and an upper end point and a lower end point of the word are flush with an upper side and a lower side of the minimum bounding rectangle respectively. In other words, the candidate region is filled with word as possible.

Through the above-mentioned method, a plurality of synthesis text images having the line text annotation box and the single character annotation box is generated, so as to solve the problem caused by the lack of annotation text at a single-character level during the training of the single character detection model.

A process of generating the pseudo label will be described hereinafter in more details.

In a possible embodiment of the present disclosure, the processing the real scenario text image set using the intermediate model includes, with respect to a line text annotation box including four vertices in the real scenario text image, performing the following operations: obtaining a height and a width of the line text annotation box; when the line text annotation box is determined as an annotation box in a first direction (e.g., a longitudinal direction) in accordance with the height and width of the line text annotation box, performing perspective transformation on a screenshot of a region where the line text annotation box is located so as to obtain a cropped image (crop_image) in a second direction (e.g., a horizontal direction), and scaling the cropped image in the second direction so as to obtain a training image adapted to the intermediate model; and when the line text annotation box is determined as an annotation box in the second direction (e.g., the horizontal direction) in accordance with the height and width of the line text annotation box, directly scaling a screenshot of a region where the annotation box in the second direction, so as to obtain a training image adapted to the intermediate model.

In the embodiments of the present disclosure, four coordinate points of the line text annotation box are arranged in a clockwise direction (e.g., upper left, upper right, lower right and lower left), and then the height and the width of the line text annotation box is calculated in accordance with the coordinate points.

In a possible embodiment of the present disclosure, when the height of the line text annotation box is greater than n*the width of the line text annotation box (n is greater than 1, e.g., 1.5), the line text annotation box is considered as an annotation box in the longitudinal direction. At this time, it is necessary to perform perspective transformation on the screenshot of the region where the line text annotation box is located, so as to obtain the cropped image in the horizontal direction for the subsequent uniform processing. Of course, in some embodiments of the present disclosure, the screenshot in the horizontal direction is transformed into the cropped image in the longitudinal direction, which will not be particularly defined herein.

In a possible embodiment of the present disclosure, the cropped image in the second direction is scaled through scale_h=min(max(64, round(crop_h/32)*32), 640), and scale_w=min(max(64, round(crop_w/32)*32), 1280), where scale_h represents the height of the scaled training image, scale_w represents the width of the scaled training image, crop_h represents a height of the cropped image in the second direction or the screenshot in the second direction, crop_w represents a width of the cropped image in the second direction or the screenshot in the second direction, 640 represents a maximum height of the training image, and 1280 represents a maximum width of the training image.

In a possible embodiment of the present disclosure, the height and the width of the training image are each divisible by m (e.g., 32, or any other value set according to the practical need).

In the above-mentioned embodiments of the present disclosure, the line text annotation box is a rectangular annotation box. In some other embodiments of the present disclosure, the line text annotation box is not rectangular annotation box (with four vertices), e.g., a curved annotation box (with more than four vertices). A method for obtaining the training image adapted to the intermediate model will be described hereinafter when the line text annotation box is a curved annotation box.

In a possible embodiment of the present disclosure, the processing the real scenario text image set using the intermediate model includes, with respect to a line text annotation box including N vertices in the real scenario text image, performing the following operations: obtaining a minimum bounding rectangle of the line text annotation box, and obtaining a ratio of an area of the line text annotation box and an area of the minimum bounding rectangle; when the ratio is smaller than a first threshold (e.g., 0.85), determining that the line text annotation box is a curved annotation box, obtaining a training image adapted to the intermediate model in accordance with four vertices of the minimum bounding rectangle, and setting values of pixels in a region of the training image other than the line text annotation box as 0, so as to prevent the introduction of the other character or background interference; and when the ratio is greater than or equal to the first threshold, determining that the line text annotation box is an approximately rectangular annotation box, and obtaining a training image adapted to the intermediate model in accordance with the four vertices of the minimum bounding rectangle, where N is greater than 4.

The obtaining the training image adapted to the intermediate model in accordance with the four vertices of the minimum bounding rectangle includes: obtaining a height and a width of the minimum bounding rectangle; when the minimum bounding rectangle is determined as an annotation box in a first direction in accordance with the height and width of the minimum bounding rectangle, performing perspective transformation on a screenshot of a region where the minimum bounding rectangle is located so as to obtain a cropped image in a first direction, and scaling the cropped image in the second direction so as to obtain a training image adapted to the intermediate model; and when the minimum bounding rectangle is determined as an annotation box in the second direction in accordance with the height and the width of the minimum bounding rectangle, directly scaling the screenshot of the region where the minimum bounding rectangle is located, so as to obtain a training image adapted to the intermediate model.

In the embodiments of the present disclosure, in such a circumstance where the line text annotation box in the real scenario text image set includes Chinese characters, the existing line text annotation is checked manually, so a height of the character is accurate. However, the width of the single character annotation box predicted through the intermediate model is relatively insufficiently large, so a generated Gaussian map tends to be flat. Hence, for the processing of Chinese data, prior to cropping the image (performing perspective transformation on the screenshot of the region where the line text annotation box or the minimum bounding rectangle is located), the height of the screenshot of the region where the line text annotation box or the minimum bounding rectangle is located needs to be enlarged.

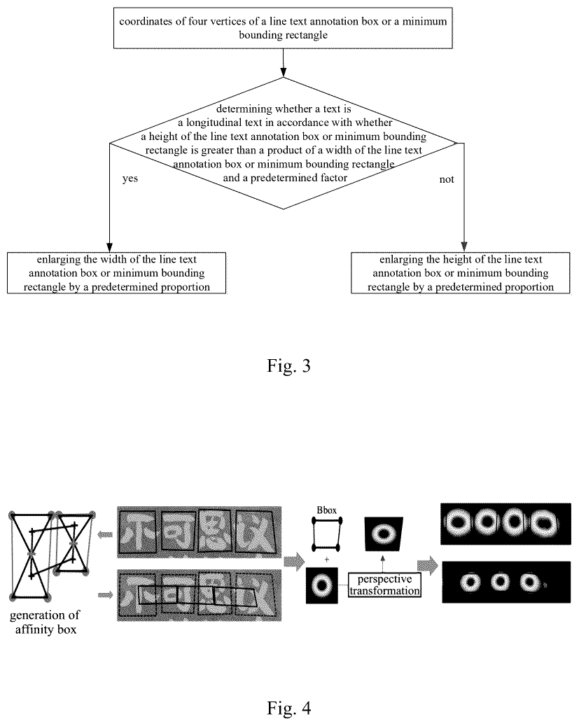

In other words, in a possible embodiment of the present disclosure, as shown in FIG. 3, when the line text annotation box in the real scenario text image includes Chinese characters, prior to performing the perspective transformation on the line text annotation box or the screenshot of the region where the minimum bounding rectangle is located, the training method further includes: determining whether a text is a longitudinal text in accordance with whether the height of the line text annotation box or the minimum bounding rectangle is greater than a product of the width of the line text annotation box or the minimum bounding rectangle and a predetermined factor (which is greater than 1, e.g., 1.5); when the height of the line text annotation box or the minimum bounding rectangle is greater than the product of the width and the predetermined factor, determining that the text is a longitudinal text, and enlarging the width of the line text annotation box or the minimum bounding rectangle by a predetermined proportion (e.g., 0.2); and when the height of the line text annotation box or the minimum bounding rectangle is smaller than or equal to the product of the width and the predetermined factor, determining that the text is not a longitudinal text, and enlarging the height of the line text annotation box or the minimum bounding rectangle by a predetermined proportion.

In the embodiments of the present disclosure, when training the initial algorithm network using the synthesis text image and training the intermediate model using the synthesis text image and the real scenario text image, it is necessary to transform the single character annotation box in the training image (the synthesis text image and/or the real scenario text image) and the inter-character region annotation box generated in accordance with the single character annotation box into the region score truth-value image and the affinity score truth-value image respectively, and then compare them with the region score prediction image and the affinity score prediction image generated by the initial algorithm network or intermediate model respectively, so as to adjust parameters of the initial algorithm network or intermediate model.

A method for transforming the single character annotation box and the inter-character region annotation box into the region score truth-value image and the affinity score truth-value image respectively will be described hereinafter.

In a possible embodiment of the present disclosure, as shown in FIG. 4, the training method further includes: generating the inter-character region annotation box (affinity box in FIG. 4) in accordance with the single character annotation box in the training image, the inter-character region annotation box being obtained through obtaining diagonal lines of each single character annotation box of two adjacent single character annotation boxes, the single character annotation box being divided into four triangles through the diagonal lines, and connecting centers of upper and lower triangles of the two adjacent single character annotation boxes to obtain the inter-character region annotation box, the training image including the synthesis text image and/or the real scenario text image having the pseudo label; encoding the single character annotation box and the inter-character region annotation box in the training image using a Gaussian function, so as to obtain two-dimensional (2D) isotropic Gaussian maps for the single character annotation box and the inter-character region annotation box; performing perspective transformation on the two-dimensional isotropic Gaussian map for the single character annotation box, and mapping the transformed two-dimensional isotropic Gaussian map into the single character annotation box, so as to obtain a first intermediate image; mapping the two-dimensional isotropic Gaussian map for the inter-character region annotation box into the inter-character region annotation box, so as to obtain a second intermediate image; and processing the first intermediate image and the second intermediate image, and outputting a region score truth-value image and an affinity score truth-value image, a region score representing a probability that each pixel in the single character annotation box is a character center, an affinity score representing a probability that each pixel in the inter-character region annotation box is a center of an inter-character region, the region score truth-value image and the affinity score truth-value image being used to train the initial algorithm network or the intermediate model.

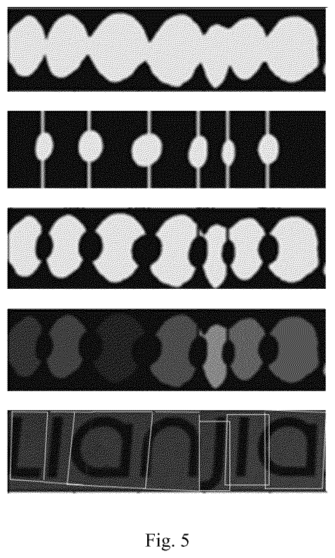

In a possible embodiment of the present disclosure, as shown in FIG. 5, the processing the real scenario text image set using the intermediate model so as to obtain the pseudo label of the real scenario text image in the real scenario text image set includes the following steps.

Step 51: performing binarization on a region score prediction image and an affinity score prediction image from the intermediate model, so as to obtain a text region mask image (as indicated by a first row in FIG. 5) and an affinity mask image.

In the embodiments of the present disclosure, the binarization is performed on the region score prediction image text_map in accordance with a region score threshold text_thre, so as to obtain the text region mask image text_mask. The binarization is performed on the affinity score prediction image link_map in accordance with an affinity score threshold link_thre, so as to obtain the affinity mask image link_mask. Values of text_thre and link_thre are set according to the practical need.

Step 52: determining a single character partition mask image (as indicated by a second row in FIG. 5) in accordance with the affinity mask image. In a possible embodiment of the present disclosure, the determining the single character partition mask image in accordance with the affinity mask image includes: determining a plurality of first connected regions (as indicated by white circle-like regions in the second row in FIG. 5) in the affinity mask image; deleting connected regions meeting a first condition from the plurality of first connected regions, so as to obtain a remaining target first connected region, the first condition including a condition about an area of the first connected region and/or a condition about a height of a center of the first connected region; obtaining maximum coordinate values of the target first connected region; and generating, with a point corresponding to the maximum coordinate values as a center, a partition bar (as indicated by vertical line-shaped regions in the second row in FIG. 5) whose width is equal to the predetermined quantity of pixels, so as to obtain the single character partition mask image including the partition bar. The single character partition mask image is used to prevent the occurrence of touching characters on the region score prediction image.

In a possible embodiment of the present disclosure, the first condition includes at least one of that a ratio of an area of the first connected region to an area of the affinity mask image is smaller than a second threshold (e.g., 0.0025) (for a circumstance where an area is too small), or that |region_yc−link_h//2|>link_h//3 (for a circumstance where a height difference is large, e.g., incomplete words are included in adjacent upper and lower lines), where region_yc represents a y-axis coordinate of a center of the first connected region, link_h represents a height of the affinity mask image, and // represents exact division.

Step 53: subtracting the single character partition mask image from the text region mask image (setting 1s in the single character partition mask image and the text region mask image as 0s), so as to obtain a plurality of second connected regions on the text region mask image (as indicated by a third row in FIG. 5).

Step 54: deleting the connected regions meeting a second condition from the plurality of second connected regions, so as to obtain a remaining target second connected region (as indicated by a fourth row in FIG. 5), the second condition including a condition about an area of the second connected region and/or a condition about a height of a center of the second connected region.

In a possible embodiment of the present disclosure, the second condition includes at least one of that a ratio of an area of the second connected region to an area of the to-be-detected text image is smaller than a third threshold (e.g., 0.003) (for such a circumstance where the second connected region has a small area relative to the training image), that |region_yc−crop_img_h//2|>crop_img_h//3 (for such a circumstance where a difference between the height of the center of the second connected region and the height of the center of the training image is greater than ⅓ of the height of the training image), or that max(text_map[region])<min_text_thre, where region_yc represents a y-axis coordinate of a center of the second connected region, text_h represents a height of the text region mask image, max(text_map[region]) represents a maximum value of region scores corresponding to single character connected regions in the region score prediction image, and min_text_thre represents a single character threshold.

Step 55: dilating the target second connected region, and taking a minimum bounding pattern for the dilated target second connected region as a predicted single character annotation box (as indicated by a fifth row in FIG. 5).

In a possible embodiment of the present disclosure, prior to subtracting the single character partition mask image from the text region mask image, the training method further includes eroding the text region mask image once or twice. The subtracting the single character partition mask image from the text region mask image includes: with respect to each second connected region, when an overlapping area between the partition bar and the second connected region is greater than a fourth threshold (e.g., 10 pixels) (for the partition of a single character) and a difference between the height of the center of the second connected region and the height of the center of the first connected region in the corresponding affinity mask image is greater than a fifth threshold (e.g., 5 pixels) (the connected regions are not located in a same row), determining that there is a plurality of rows of words in a line text annotation box in the region score prediction image; and defining a height of the partition bar in accordance with the second connected region in the text region mask image.

In a possible embodiment of the present disclosure, each pseudo label corresponds to a confidence level. The training the intermediate model using the synthesis text image set and the real scenario text image set having the pseudo label includes: calculating a loss in accordance with the confidence level of the pseudo label (i.e., a weighed value is provided for each pixel point in the loss calculation, so as to reduce a weight of an inaccurate pseudo label in the loss); and adjusting a parameter of the intermediate model in accordance with the loss.

In a possible embodiment of the present disclosure, the confidence level is calculated through

$${S}_{conf} ( w ) = \frac{l ( w ) - min ( l ( w ) , \vert l ( w ) - {l}^{c} ( w ) \vert )}{l ( w )} ,$$

where S_{conf}(w) represents the confidence level, l(w) represents the quantity of characters annotated manually, and l^{c}(w) represents the predicted quantity of characters. When the confidence level is smaller than a fifth threshold (e.g., 0.5) and the line text annotation box in the training image is a rectangular annotation box (i.e., the quantity of vertices is 4), the confidence level is reset to the fifth threshold (at this time, the line text annotation box is evenly divided into the single character annotation boxes), and when the confidence level is smaller than the fifth threshold (e.g., 0.5) and the line text annotation box in the training image is a curved annotation box (i.e., the quantity of vertices is greater than 4), the confidence level is reset to 0, i.e., a curved annotation region which is predicted inaccurately is omitted.

In the embodiments of the present disclosure, a processing range of the pseudo label is extended so as to support the curved annotation as well as a plurality of rows of text annotation data (a plurality of rows of words in one annotation box). In addition, a watershed algorithm (an image partition algorithm) is used by the CRAFT to partition the region score prediction image from the intermediate model, so as to obtain the single character annotation box. However, at this time, touching English characters easily occur. Hence, the characters are partitioned through the affinity score prediction image, so as to prevent the occurrence of the touching English characters.

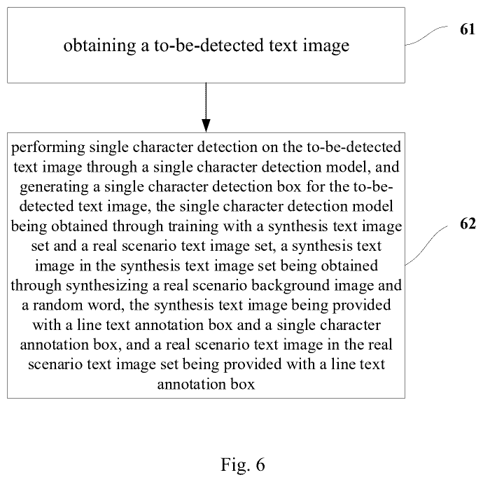

As shown in FIG. 6, the present disclosure further provides in some embodiments a single character detection method, which includes: Step 61 of obtaining a to-be-detected text image; and Step 62 of performing single character detection on the to-be-detected text image through a single character detection model, and generating a single character detection box for the to-be-detected text image, the single character detection model being obtained through training with a synthesis text image set and a real scenario text image set, a synthesis text image in the synthesis text image set being obtained through synthesizing a real scenario background image and a random word, the synthesis text image being provided with a line text annotation box and a single character annotation box, and a real scenario text image in the real scenario text image set being provided with a line text annotation box.

In the embodiments of the present disclosure, the single character detection model is trained using the synthesis text image, so it is able to solve the problem caused by the lack of annotation text at a single-character level. In addition, the training is performed in conjunction with the real scenario text image set, so it is able to increase the accuracy of the single character detection model.

In a possible embodiment of the present disclosure, the single character detection model uses a multi-scale feature fusion residual network, e.g., an ResNet50+FPN structure.

In a possible embodiment of the present disclosure, the synthesis text image set includes at least one of a single Chinese character synthesis text image set or a single English character synthesis text image set.

In a possible embodiment of the present disclosure, the performing the single character detection on the to-be-detected text image through the single character detection model and generating the single character detection box for the to-be-detected text image includes: performing the single character detection on the to-be-detected text image, so as to obtain a region score prediction image and an affinity score prediction image; performing binarization on the region score prediction image and the affinity score prediction image, so as to obtain a text region mask image and an affinity mask image; determining a single character partition mask image in accordance with the affinity mask image; subtracting the single character partition mask image from the text region mask image, so as to obtain a plurality of second connected regions on the text region mask image; deleting the connected regions meeting a second condition from the plurality of second connected regions, so as to obtain a remaining target second connected region, the second condition including a condition about an area of the second connected region and/or a condition about a height of a center of the second connected region; and dilating the target second connected region, and taking a minimum bounding pattern for the dilated target second connected region as a predicted single character annotation box.

In a possible embodiment of the present disclosure, the determining the single character partition mask image in accordance with the affinity mask image includes: determining a plurality of first connected regions in the affinity mask image; deleting connected regions meeting a first condition from the plurality of first connected regions, so as to obtain a remaining target first connected region, the first condition including a condition about an area of the first connected region and/or a condition about a height of a center of the first connected region; obtaining maximum coordinate values of the target first connected region; and generating, with a point corresponding to the maximum coordinate values as a center, a partition bar whose width is equal to the predetermined quantity of pixels, so as to obtain the single character partition mask image including the partition bar.

In a possible embodiment of the present disclosure, the first condition includes at least one of that a ratio of an area of the first connected region to an area of the affinity mask image is smaller than a second threshold, or that |region_yc−link_h//2|>link_h//3, where region_yc represents a y-axis coordinate of a center of the first connected region, and link_h represents a height of the affinity mask image; and/or the second condition includes at least one of that a ratio of an area of the second connected region to an area of the to-be-detected text image is smaller than a third threshold, that |region_yc−crop_img_h//2|>crop_img_h//3, or that max(text_map[region])<min_text_thre, where region_yc represents a y-axis coordinate of a center of the second connected region, crop_img_h represents a height of the to-be-detected text image, max(text_map[region]) represents a maximum value of region scores corresponding to single character connected regions in the region score prediction image, and min_text_thre represents a single character threshold.

In a possible embodiment of the present disclosure, prior to subtracting the single character partition mask image from the text region mask image, the single character detection method further includes eroding the text region mask image. The subtracting the single character partition mask image from the text region mask image includes: with respect to each second connected region, when an overlapping area between the partition bar and the second connected region is greater than a fourth threshold and a difference between the height of the center of the second connected region and the height of the center of the first connected region in the corresponding affinity mask image is greater than a fifth threshold, determining that there is a plurality of rows of words in a line text annotation box in the region score prediction image; and defining a height of the partition bar in accordance with the second connected region in the text region mask image.

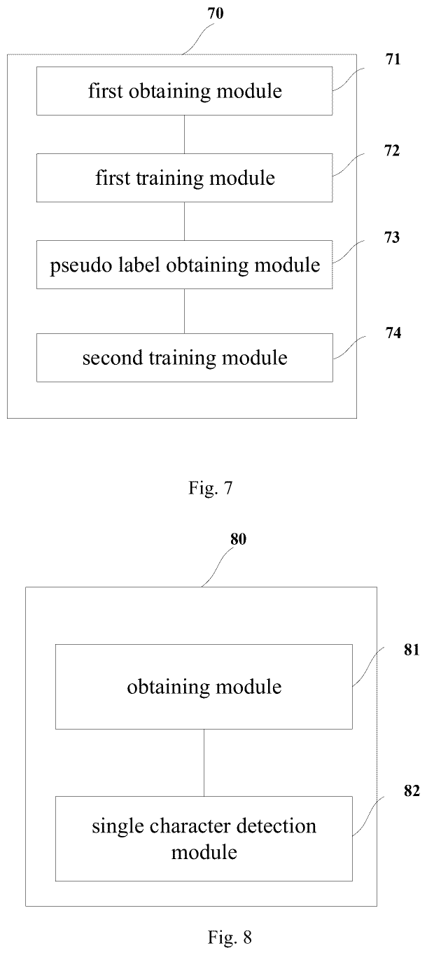

As shown in FIG. 7, the present disclosure further provides in some embodiments a training device 70 for a single character detection model, which includes: a first obtaining module 71 configured to obtain a synthesis text image set, a synthesis text image in the synthesis text image set being obtained through synthesizing a real scenario background image and a random word, the synthesis text image being provided with a line text annotation box and a single character annotation box; a first training module 72 configured to train an initial algorithm network using the synthesis text image set, so as to obtain an intermediate model for single character detection; a pseudo label obtaining module 73 configured to process a real scenario text image set using the intermediate model, so as to obtain a pseudo label of a real scenario text image in the real scenario text image set, the real scenario text image being provided with a line text annotation box, the pseudo label being a single character annotation box; and a second training module 74 configured to train the intermediate model using the synthesis text image set and the real scenario text image set having the pseudo label, so as to obtain the single character detection model for single character detection.

In a possible embodiment of the present disclosure, the synthesis text image set includes at least one of a single Chinese character synthesis text image set or a single English character synthesis text image set.

In a possible embodiment of the present disclosure, the first obtaining module 71 is configured to: select a real scenario background image; partition the real scenario background image into a plurality of partition regions, the partition regions having a same texture and/or a same color; perform image depth estimation on the real scenario background image, so as to obtain depth information about each partition region in the real scenario background image; screen the partition regions in accordance with a size and an aspect ratio of each partition region and/or the depth information about the partition region, so as to obtain candidate regions; randomly selecting the candidate regions; with respect to each selected candidate region, perform the following operations until all the candidate regions have been processed: rendering a randomly-selected word in accordance with a color of the candidate region, so as to obtain the rendered word; obtaining a minimum bounding rectangle of the candidate region; obtaining a space plane corresponding to the minimum bounding rectangle in accordance with the depth information about the candidate region; performing perspective transformation on the candidate region in accordance with the space plane, so as to transform the space plane of the candidate region into a target plane parallel to a screen; pasting the rendered word to the transformed candidate region; and performing inverse perspective transformation on the transformed candidate region; and map all the processed candidate regions back to the real scenario background image to obtain the synthesis text image, and determine the line text annotation box and the single character annotation box in the synthesis text image.

In a possible embodiment of the present disclosure, the initial algorithm network, the intermediate model and the single character detection model use a multi-scale feature fusion residual network, e.g., an ResNet50+FPN structure.

In a possible embodiment of the present disclosure, the training device further includes an execution module configured to: with respect to a line text annotation box including four vertices in the real scenario text image, perform the following operations: obtaining a height and a width of the line text annotation box; when the line text annotation box is determined as an annotation box in a first direction in accordance with the height and width of the line text annotation box, performing perspective transformation on a screenshot of a region where the line text annotation box is located so as to obtain a cropped image in a second direction, and scaling the cropped image in the second direction so as to obtain a training image adapted to the intermediate model; and when the line text annotation box is determined as an annotation box in the second direction in accordance with the height and width of the line text annotation box, directly scaling a screenshot of a region where the annotation box in the second direction, so as to obtain a training image adapted to the intermediate model; and/or with respect to a line text annotation box including N vertices in the real scenario text image, perform the following operations: obtaining a minimum bounding rectangle of the line text annotation box, and obtaining a ratio of an area of the line text annotation box and an area of the minimum bounding rectangle; when the ratio is smaller than a first threshold, determining that the line text annotation box is a curved annotation box, obtaining a training image adapted to the intermediate model in accordance with four vertices of the minimum bounding rectangle, and setting values of pixels in a region of the training image other than the line text annotation box as 0; and when the ratio is greater than or equal to the first threshold, determining that the line text annotation box is an approximately rectangular annotation box, and obtaining a training image adapted to the intermediate model in accordance with the four vertices of the minimum bounding rectangle, where N is greater than 4. The obtaining the training image adapted to the intermediate model in accordance with the four vertices of the minimum bounding rectangle includes: obtaining a height and a width of the minimum bounding rectangle; when the minimum bounding rectangle is determined as an annotation box in a first direction in accordance with the height and width of the minimum bounding rectangle, performing perspective transformation on a screenshot of a region where the minimum bounding rectangle is located so as to obtain a cropped image in a first direction, and scaling the cropped image in the second direction so as to obtain a training image adapted to the intermediate model; and when the minimum bounding rectangle is determined as an annotation box in the second direction in accordance with the height and the width of the minimum bounding rectangle, directly scaling the screenshot of the region where the minimum bounding rectangle is located, so as to obtain a training image adapted to the intermediate model.

In a possible embodiment of the present disclosure, when the line text annotation box in the real scenario text image includes Chinese characters, prior to performing the perspective transformation on the line text annotation box or the screenshot of the region where the minimum bounding rectangle is located, the execution module is further configured to: determine whether a text is a longitudinal text in accordance with whether the height of the line text annotation box or the minimum bounding rectangle is greater than a product of the width of the line text annotation box or the minimum bounding rectangle and a predetermined factor; when the height of the line text annotation box or the minimum bounding rectangle is greater than the product of the width and the predetermined factor, determine that the text is a longitudinal text, and enlarge the width of the line text annotation box or the minimum bounding rectangle by a predetermined proportion; and when the height of the line text annotation box or the minimum bounding rectangle is smaller than or equal to the product of the width and the predetermined factor, determine that the text is not a longitudinal text, and enlarge the height of the line text annotation box or the minimum bounding rectangle by a predetermined proportion.

In a possible embodiment of the present disclosure, the training device further includes a truth value generation module configured to: generate an inter-character region annotation box in accordance with a single character annotation box in a training image, the inter-character region annotation box being obtained through obtaining diagonal lines of each single character annotation box of two adjacent single character annotation boxes, the single character annotation box being divided into four triangles through the diagonal lines, and connecting centers of upper and lower triangles of the two adjacent single character annotation boxes to obtain the inter-character region annotation box, the training image including the synthesis text image and/or the real scenario text image having the pseudo label; encode the single character annotation box and the inter-character region annotation box in the training image using a Gaussian function, so as to obtain two-dimensional isotropic Gaussian maps for the single character annotation box and the inter-character region annotation box; perform perspective transformation on the two-dimensional isotropic Gaussian map for the single character annotation box, and map the transformed two-dimensional isotropic Gaussian map into the single character annotation box, so as to obtain a first intermediate image; map the two-dimensional isotropic Gaussian map for the inter-character region annotation box into the inter-character region annotation box, so as to obtain a second intermediate image; and process the first intermediate image and the second intermediate image, and output a region score truth-value image and an affinity score truth-value image, a region score representing a probability that each pixel in the single character annotation box is a character center, an affinity score representing a probability that each pixel in the inter-character region annotation box is a center of an inter-character region, the region score truth-value image and the affinity score truth-value image being used to train the initial algorithm network or the intermediate model.

In a possible embodiment of the present disclosure, the pseudo label obtaining module 73 is configured to: perform binarization on a region score prediction image and an affinity score prediction image from the intermediate model, so as to obtain a text region mask image and an affinity mask image; determine a single character partition mask image in accordance with the affinity mask image; subtract the single character partition mask image from the text region mask image, so as to obtain a plurality of second connected regions on the text region mask image; delete the connected regions meeting a second condition from the plurality of second connected regions, so as to obtain a remaining target second connected region, the second condition including a condition about an area of the second connected region and/or a condition about a height of a center of the second connected region; and dilate the target second connected region, and take a minimum bounding pattern for the dilated target second connected region as a predicted single character annotation box.

In a possible embodiment of the present disclosure, the determining the single character partition mask image in accordance with the affinity mask image includes: determining a plurality of first connected regions in the affinity mask image; deleting connected regions meeting a first condition from the plurality of first connected regions, so as to obtain a remaining target first connected region, the first condition including a condition about an area of the first connected region and/or a condition about a height of a center of the first connected region; obtaining maximum coordinate values of the target first connected region; and generating, with a point corresponding to the maximum coordinate values as a center, a partition bar whose width is equal to the predetermined quantity of pixels, so as to obtain the single character partition mask image including the partition bar.

In a possible embodiment of the present disclosure, the first condition includes at least one of that a ratio of an area of the first connected region to an area of the affinity mask image is smaller than a second threshold, or that |region_yc−link_h//2|>link_h//3, where region_yc represents a y-axis coordinate of a center of the first connected region, and link_h represents a height of the affinity mask image; and/or the second condition includes at least one of that a ratio of an area of the second connected region to an area of the to-be-detected text image is smaller than a third threshold, that |region_yc−crop_img_h//2|>crop_img_h//3, or that max(text_map[region])<min_text_thre, where region_yc represents a y-axis coordinate of a center of the second connected region, text_h represents a height of the text region mask image, max(text_map[region]) represents a maximum value of region scores corresponding to single character connected regions in the region score prediction image, and min_text_thre represents a single character threshold.

In a possible embodiment of the present disclosure, prior to subtracting the single character partition mask image from the text region mask image, the pseudo label obtaining module is further configured to erode the text region mask image. The subtracting the single character partition mask image from the text region mask image includes: with respect to each second connected region, when an overlapping area between the partition bar and the second connected region is greater than a fourth threshold and a difference between the height of the center of the second connected region and the height of the center of the first connected region in the corresponding affinity mask image is greater than a fifth threshold, determining that there is a plurality of rows of words in a line text annotation box in the region score prediction image; and defining a height of the partition bar in accordance with the second connected region in the text region mask image.

In a possible embodiment of the present disclosure, each pseudo label corresponds to a confidence level. The first training module 71 is configured to: calculate a loss in accordance with the confidence level of the pseudo label; and adjust a parameter of the intermediate model in accordance with the loss.

In a possible embodiment of the present disclosure, the confidence level is calculated through

$${S}_{conf} ( w ) = \frac{l ( w ) - min ( l ( w ) , \vert l ( w ) - {l}^{c} ( w ) \vert )}{l ( w )} ,$$

where S_{conf}(w) represents the confidence level, l(w) represents the quantity of characters annotated manually, and l^{c}(w) represents the predicted quantity of characters. When the confidence level is smaller than a fifth threshold and the line text annotation box in the training image is a rectangular annotation box, the confidence level is reset to the fifth threshold, and when the confidence level is smaller than the fifth threshold and the line text annotation box in the training image is a curved annotation box, the confidence level is reset to 0.

As shown in FIG. 8, the present disclosure further provides in some embodiments a single character detection device 80, which includes: an obtaining module 81 configured to obtain a to-be-detected text image; and a single character detection module 82 configured to perform single character detection on the to-be-detected text image through a single character detection model, and generate a single character detection box for the to-be-detected text image, the single character detection model being obtained through training with a synthesis text image set and a real scenario text image set, a synthesis text image in the synthesis text image set being obtained through synthesizing a real scenario background image and a random word, the synthesis text image being provided with a line text annotation box and a single character annotation box, and a real scenario text image in the real scenario text image set being provided with a line text annotation box.

In a possible embodiment of the present disclosure, the single character detection model uses a multi-scale feature fusion residual network, e.g., an ResNet50+FPN structure.

In a possible embodiment of the present disclosure, the synthesis text image set includes at least one of a single Chinese character synthesis text image set or a single English character synthesis text image set.

In a possible embodiment of the present disclosure, the single character detection module 82 is configured to: perform the single character detection on the to-be-detected text image, so as to obtain a region score prediction image and an affinity score prediction image; perform binarization on the region score prediction image and the affinity score prediction image, so as to obtain a text region mask image and an affinity mask image; determine a single character partition mask image in accordance with the affinity mask image; subtract the single character partition mask image from the text region mask image, so as to obtain a plurality of second connected regions on the text region mask image; delete the connected regions meeting a second condition from the plurality of second connected regions, so as to obtain a remaining target second connected region, the second condition including a condition about an area of the second connected region and/or a condition about a height of a center of the second connected region; and dilate the target second connected region, and take a minimum bounding pattern for the dilated target second connected region as a predicted single character annotation box.

In a possible embodiment of the present disclosure, the determining the single character partition mask image in accordance with the affinity mask image includes: determining a plurality of first connected regions in the affinity mask image; deleting connected regions meeting a first condition from the plurality of first connected regions, so as to obtain a remaining target first connected region, the first condition including a condition about an area of the first connected region and/or a condition about a height of a center of the first connected region; obtaining maximum coordinate values of the target first connected region; and generating, with a point corresponding to the maximum coordinate values as a center, a partition bar whose width is equal to the predetermined quantity of pixels, so as to obtain the single character partition mask image including the partition bar.

In a possible embodiment of the present disclosure, the first condition includes at least one of that a ratio of an area of the first connected region to an area of the affinity mask image is smaller than a second threshold, or that |region_yc−link_h//2|>link_h//3, where region_yc represents a y-axis coordinate of a center of the first connected region, and link_h represents a height of the affinity mask image; and/or the second condition includes at least one of that a ratio of an area of the second connected region to an area of the to-be-detected text image is smaller than a third threshold, that |region_yc−crop_img_h//2|>crop_img_h//3, or that max(text_map[region])<min_text_thre, where region_yc represents a y-axis coordinate of a center of the second connected region, crop_img_h represents a height of the to-be-detected text image, max(text_map[region]) represents a maximum value of region scores corresponding to single character connected regions in the region score prediction image, and min_text_thre represents a single character threshold.

In a possible embodiment of the present disclosure, prior to subtracting the single character partition mask image from the text region mask image, the single character detection module 82 is further configured to erode the text region mask image. The subtracting the single character partition mask image from the text region mask image includes: with respect to each second connected region, when an overlapping area between the partition bar and the second connected region is greater than a fourth threshold and a difference between the height of the center of the second connected region and the height of the center of the first connected region in the corresponding affinity mask image is greater than a fifth threshold, determining that there is a plurality of rows of words in a line text annotation box in the region score prediction image; and defining a height of the partition bar in accordance with the second connected region in the text region mask image.

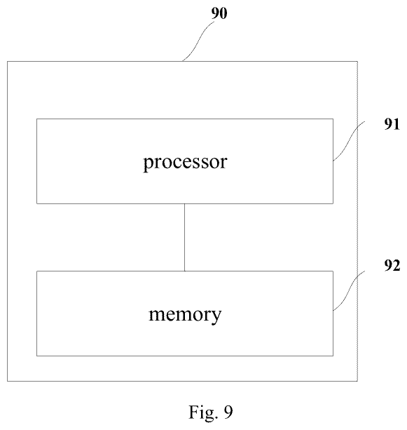

As shown in FIG. 9, the present disclosure further provides in some embodiments an electronic apparatus 90, which includes a processor 91, a memory 92, and a program stored in the memory 92 and executed by the processor 91. The program is executed by the processor 91 so as to implement the steps of the above-mentioned single character detection method, or the steps of the above-mentioned training method for the single character detection model with a same technical effect, which will not be particularly defined herein.

The present disclosure further provides in some embodiments a non-transient computer-readable storage medium storing therein a computer program. The computer program is executed by a processor so as to implement the steps of the above-mentioned single character detection method, or the steps of the above-mentioned training method for the single character detection model with a same technical effect, which will not be particularly defined herein. The non-transient computer-readable storage medium includes Read Only Memory (ROM), Random Access Memory (RAM), magnetic disk or optical disk.

It should be appreciated that, the word “include” or “including” or any other variations involved in the embodiments of the present disclosure intend to provide non-exclusive coverage, so that a procedure, method, article or device including a series of elements may also include any other elements not listed herein, or may include any inherent elements of the procedure, method, article or device. If without any further limitations, for the elements defined by such sentence as “including one . . . ”, it is not excluded that the procedure, method, article or device including the elements may also include any other identical elements.

Through the above-mentioned description, it may be apparent for a person skilled in the art that the present disclosure may be implemented by software as well as a necessary common hardware platform, or by hardware, and the former may be better in most cases. Based on this, the technical solutions of the present disclosure, partial or full, or parts of the technical solutions of the present disclosure contributing to the related art, may appear in the form of software products, which may be stored in a storage medium (e.g., ROM/RAM, magnetic disk or optical disk) and include several instructions so as to enable a terminal device (mobile phone, computer, server, air conditioner or network device) to execute the method in the embodiments of the present disclosure.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A detection method, comprising:
obtaining a to-be-detected text image; and
performing single character detection on the to-be-detected text image through a single character detection model, and generating a single character detection box for the to-be-detected text image, the single character detection model being obtained through training with a synthesis text image set and a real scenario text image set, a synthesis text image in the synthesis text image set being obtained through synthesizing a real scenario background image and a random word, the synthesis text image being provided with a line text annotation box and a single character annotation box, and a real scenario text image in the real scenario text image set being provided with a line text annotation box.

2. The detection method according to claim 1, wherein the single character detection model adopts a multi-scale feature fusion residual network.

3. The detection method according to claim 1, wherein the synthesis text image set comprises at least one of a single Chinese character synthesis text image set or a single English character synthesis text image set.

4. The detection method according to claim 1, wherein the performing the single character detection on the to-be-detected text image through the single character detection model and generating the single character detection box for the to-be-detected text image comprises:
performing the single character detection on the to-be-detected text image by using the single character detection model, so as to obtain a region score prediction image and an affinity score prediction image;
performing binarization on the region score prediction image and the affinity score prediction image, so as to obtain a text region mask image and an affinity mask image;
determining a single character partition mask image in accordance with the affinity mask image;
subtracting the single character partition mask image from the text region mask image, so as to obtain a plurality of second connected regions on the text region mask image;
deleting connected regions meeting a second condition from the plurality of second connected regions, so as to obtain a remaining target second connected region, the second condition comprising a condition about an area of the second connected region and/or a condition about a height of a center of the second connected region; and
dilating the target second connected region, and taking a minimum bounding pattern for the dilated target second connected region as a predicted single character annotation box.

5. The detection method according to claim 4, wherein the determining the single character partition mask image in accordance with the affinity mask image comprises:
determining a plurality of first connected regions in the affinity mask image;
deleting connected regions meeting a first condition from the plurality of first connected regions, so as to obtain a remaining target first connected region, the first condition comprising a condition about an area of the first connected region and/or a condition about a height of a center of the first connected region;
obtaining maximum coordinate values of the target first connected region; and
generating, with a point corresponding to the maximum coordinate values as a center, a partition bar whose width is equal to the predetermined quantity of pixels, so as to obtain the single character partition mask image comprising the partition bar.

6. The detection method according to claim 5, wherein the first condition comprises at least one of that a ratio of the area of the first connected region to an area of the affinity mask image is smaller than a second threshold, or that |region_yc−link_h//2|>link_h//3, wherein region_yc represents a y-axis coordinate of the center of the first connected region, and link_h represents the height of the affinity mask image; and/or
the second condition comprises at least one of that a ratio of the area of the second connected region to an area of the to-be-detected text image is smaller than a third threshold, that |region_yc−crop_img_h//2|>crop_img_h//3, or that max(text_map[region])<min_text_thre, wherein region_yc represents a y-axis coordinate of the center of the second connected region, crop_img_h represents a height of the to-be-detected text image, max(text_map[region]) represents a maximum value of region scores corresponding to single character connected regions in the region score prediction image, and min_text_thre represents a single character threshold.

7. The detection method according to claim 5, wherein prior to subtracting the single character partition mask image from the text region mask image, the single character detection method further comprises eroding the text region mask image,
wherein the subtracting the single character partition mask image from the text region mask image comprises:
with respect to each second connected region, when an overlapping area between the partition bar and the second connected region is greater than a fourth threshold and a difference between the height of the center of the second connected region and the height of the center of the first connected region in the corresponding affinity mask image is greater than a fifth threshold, determining that there is a plurality of rows of words in a line text annotation box in the region score prediction image; and
defining a height of the partition bar in accordance with the second connected region in the text region mask image.

8. A training method for a single character detection model, comprising:
obtaining a synthesis text image set, a synthesis text image in the synthesis text image set being obtained through synthesizing a real scenario background image and a random word, the synthesis text image being provided with a line text annotation box and a single character annotation box;
training an initial algorithm network using the synthesis text image set, so as to obtain an intermediate model for single character detection;
processing a real scenario text image set using the intermediate model, so as to obtain a pseudo label of a real scenario text image in the real scenario text image set, the real scenario text image being provided with a line text annotation box, the pseudo label being a single character annotation box; and
training the intermediate model using the synthesis text image set and the real scenario text image set having the pseudo label, so as to obtain the single character detection model for single character detection.

9. The training method according to claim 8, wherein the synthesis text image set comprises at least one of a single Chinese character synthesis text image set or a single English character synthesis text image set.

10. The training method according to claim 8, wherein the obtaining the synthesis text image set comprises:
selecting a real scenario background image;
partitioning the real scenario background image into a plurality of partition regions, wherein the partition regions have a same texture and/or a same color;
performing image depth estimation on the real scenario background image, so as to obtain depth information about each partition region in the real scenario background image;
screening the partition regions in accordance with a size and an aspect ratio of each partition region and/or the depth information about the partition region, so as to obtain candidate regions;
randomly selecting the candidate regions;
with respect to each selected candidate region, performing the following operations until all the candidate regions have been processed: rendering a randomly-selected word in accordance with a color of the candidate region, so as to obtain the rendered word; obtaining a minimum bounding rectangle of the candidate region; obtaining a space plane corresponding to the minimum bounding rectangle in accordance with the depth information about the candidate region; performing perspective transformation on the candidate region in accordance with the space plane, so as to transform the space plane of the candidate region into a target plane parallel to a screen; pasting the rendered word to the transformed candidate region; and performing inverse perspective transformation on the transformed candidate region; and
mapping all the processed candidate regions back to the real scenario background image to obtain the synthesis text image, and determining the line text annotation box and the single character annotation box in the synthesis text image.

11. The training method according to claim 8, wherein the initial algorithm network, the intermediate model and the single character detection model adapts a multi-scale feature fusion residual network.

12. The training method according to claim 8, wherein prior to processing the real scenario text image set using the intermediate model, the training method further comprises:
with respect to a line text annotation box comprising four vertices in the real scenario text image, performing the following operations:
obtaining a height and a width of the line text annotation box;
when the line text annotation box is determined as an annotation box in a first direction in accordance with the height and width of the line text annotation box, performing perspective transformation on a screenshot of a region where the line text annotation box is located so as to obtain a cropped image in a second direction, and scaling the cropped image in the second direction so as to obtain a training image adapted to the intermediate model; and
when the line text annotation box is determined as an annotation box in the second direction in accordance with the height and width of the line text annotation box, directly scaling a screenshot of a region where the annotation box in the second direction, so as to obtain a training image adapted to the intermediate model; and/or
with respect to a line text annotation box comprising N vertices in the real scenario text image, performing the following operations, wherein N is greater than 4:
obtaining a minimum bounding rectangle of the line text annotation box, and obtaining a ratio of an area of the line text annotation box and an area of the minimum bounding rectangle;
when the ratio is smaller than a first threshold, determining that the line text annotation box is a curved annotation box, obtaining a training image adapted to the intermediate model in accordance with four vertices of the minimum bounding rectangle, and setting values of pixels in a region of the training image other than the line text annotation box as 0; and
when the ratio is greater than or equal to the first threshold, determining that the line text annotation box is an approximately rectangular annotation box, and obtaining a training image adapted to the intermediate model in accordance with the four vertices of the minimum bounding rectangle,
wherein the obtaining the training image adapted to the intermediate model in accordance with the four vertices of the minimum bounding rectangle comprises:
obtaining a height and a width of the minimum bounding rectangle;
when the minimum bounding rectangle is determined as an annotation box in a first direction in accordance with the height and width of the minimum bounding rectangle, performing perspective transformation on a screenshot of a region where the minimum bounding rectangle is located so as to obtain a cropped image in a second direction, and scaling the cropped image in the second direction so as to obtain a training image adapted to the intermediate model; and
when the minimum bounding rectangle is determined as an annotation box in the second direction in accordance with the height and the width of the minimum bounding rectangle, directly scaling the screenshot of the region where the minimum bounding rectangle is located, so as to obtain a training image adapted to the intermediate model.

13. The training method according to claim 12, wherein when the line text annotation box in the real scenario text image comprises Chinese characters, prior to performing the perspective transformation on the line text annotation box or the screenshot of the region where the minimum bounding rectangle is located, the training method further comprises:
determining whether a text is a longitudinal text in accordance with whether the height of the line text annotation box or the minimum bounding rectangle is greater than a product of the width of the line text annotation box or the minimum bounding rectangle and a predetermined factor;
when the height of the line text annotation box or the minimum bounding rectangle is greater than the product of the width and the predetermined factor, determining that the text is a longitudinal text, and enlarging the width of the line text annotation box or the minimum bounding rectangle by a predetermined proportion; and
when the height of the line text annotation box or the minimum bounding rectangle is smaller than or equal to the product of the width and the predetermined factor, determining that the text is not a longitudinal text, and enlarging the height of the line text annotation box or the minimum bounding rectangle by a predetermined proportion.

14. The training method according to claim 8, further comprising:
generating an inter-character region annotation box in accordance with a single character annotation box in a training image, the inter-character region annotation box being obtained through obtaining diagonal lines of each single character annotation box of two adjacent single character annotation boxes, the single character annotation box being divided into four triangles through the diagonal lines, and connecting centers of upper and lower triangles of the two adjacent single character annotation boxes to obtain the inter-character region annotation box, the training image comprising the synthesis text image and/or the real scenario text image having the pseudo label;
encoding the single character annotation box and the inter-character region annotation box in the training image using a Gaussian function, so as to obtain two-dimensional isotropic Gaussian maps for the single character annotation box and the inter-character region annotation box;
performing perspective transformation on the two-dimensional isotropic Gaussian map for the single character annotation box, and mapping the transformed two-dimensional isotropic Gaussian map into the single character annotation box, so as to obtain a first intermediate image;
mapping the two-dimensional isotropic Gaussian map for the inter-character region annotation box into the inter-character region annotation box, so as to obtain a second intermediate image; and
processing the first intermediate image and the second intermediate image, and outputting a region score truth-value image and an affinity score truth-value image, a region score representing a probability that each pixel in the single character annotation box is a character center, an affinity score representing a probability that each pixel in the inter-character region annotation box is a center of an inter-character region, the region score truth-value image and the affinity score truth-value image being used to train the initial algorithm network or the intermediate model.

15. The training method according to claim 8, wherein the processing the real scenario text image set using the intermediate model so as to obtain the pseudo label of the real scenario text image in the real scenario text image set comprises:
performing binarization on a region score prediction image and an affinity score prediction image outputted from the intermediate model, so as to obtain a text region mask image and an affinity mask image;
determining a single character partition mask image in accordance with the affinity mask image;
subtracting the single character partition mask image from the text region mask image, so as to obtain a plurality of second connected regions on the text region mask image;
deleting the connected regions meeting a second condition from the plurality of second connected regions, so as to obtain a remaining target second connected region, the second condition comprising a condition about an area of the second connected region and/or a condition about a height of a center of the second connected region; and
dilating the target second connected region, and taking a minimum bounding pattern for the dilated target second connected region as a predicted single character annotation box.

16. The training method according to claim 15, wherein the determining the single character partition mask image in accordance with the affinity mask image comprises:
determining a plurality of first connected regions in the affinity mask image;
deleting connected regions meeting a first condition from the plurality of first connected regions, so as to obtain a remaining target first connected region, the first condition comprising a condition about an area of the first connected region and/or a condition about a height of a center of the first connected region;
obtaining maximum coordinate values of the target first connected region; and
generating, with a point corresponding to the maximum coordinate values as a center, a partition bar whose width is equal to the predetermined quantity of pixels, so as to obtain the single character partition mask image comprising the partition bar,
wherein the first condition comprises at least one of that a ratio of an area of the first connected region to an area of the affinity mask image is smaller than a second threshold, or that |region_yc−link_h//2|>link_h//3, wherein region_yc represents a y-axis coordinate of a center of the first connected region, and link_h represents a height of the affinity mask image; and/or
the second condition comprises at least one of that a ratio of an area of the second connected region to an area of the to-be-detected text image is smaller than a third threshold, that |region_yc−crop_img_h//2|>crop_img_h//3, or that max(text_map[region])<min_text_thre, wherein region_yc represents a y-axis coordinate of a center of the second connected region, text_h represents a height of the text region mask image, max(text_map[region]) represents a maximum value of region scores corresponding to single character connected regions in the region score prediction image, and min_text_thre represents a single character threshold.

17. (canceled)

18. The training method according to claim 15, wherein prior to subtracting the single character partition mask image from the text region mask image, the training method further comprises eroding the text region mask image,
wherein the subtracting the single character partition mask image from the text region mask image comprises:
with respect to each second connected region, when an overlapping area between the partition bar and the second connected region is greater than a fourth threshold and a difference between the height of the center of the second connected region and the height of the center of the first connected region in the corresponding affinity mask image is greater than a fifth threshold, determining that there is a plurality of rows of words in a line text annotation box in the region score prediction image; and
defining a height of the partition bar in accordance with the second connected region in the text region mask image.

19. (canceled)

20. (canceled)

21. An electronic apparatus, comprising a processor, a memory, and a program stored in the memory and executed by the processor, wherein the program is executed by the processor so as to implement the steps of the detection method according to claim 1.

22. A non-transient computer-readable storage medium storing therein a computer program, wherein the computer program is executed by a processor so as to implement the steps of the detection method according to claim 1.

23. An electronic apparatus, comprising a processor, a memory, and a program stored in the memory and executed by the processor, wherein the program is executed by the processor so as to implement the steps of the detection method according to claim 8.
